(19) United States
(12) Patent Application Publication
(10) Pub. No.: US 2025/0036433 A1
(43) Pub. Date: Jan. 30, 2025

(54) METHODS AND SYSTEMS FOR ADAPTIVE AND PERSONALIZED TEXT AND VISUALS OF ELECTRONIC CONTENT

(71) Applicant: Edify Technologies, Inc., Denver, CO (US)

(72) Inventor: Jacob Mellman Zax, Denver, CO (US)

(73) Assignee: Edify Technologies, Inc., Denver, CO (US)

(21) Appl. No.: 18/783,114

(22) Filed: Jul. 24, 2024

Related U.S. Application Data
(60) Provisional application No. 63/515,533, filed on Jul. 25, 2023.

(51) Int. Cl. G06F 9/451; G06F 3/01; H04L 67/306

(52) U.S. Cl. CPC G06F 9/451; G06F 3/011; H04L 67/306

(57) ABSTRACT

Systems and methods are disclosed for generation, adaptive configuration, and personalized display of text and visuals on electronic devices. The multi-level adaptive system may determine and present a configuration of text and visuals that is customized for a specific user's capacity, interests, and needs when that user takes any physical action to reveal more material in a digital work displayed on an electronic device. An embodiment of the invention adapts an electronic presentation in real-time so that the graphics, language (words, sentences, paragraphs etc.), and overall structure of the work becomes dynamic and responsive to the context of individual users, rather than operating as a static object. In one particular example, delivering personalized text and visuals on electronic devices may entail three technology system components: a machine-learning or artificial intelligence (AI) platform; a display program, and a computing device comprising a display.

### RELATED APPLICATIONS

This application claims priority to U.S. Provisional Patent Ser. No. 63/515,533, filed Jul. 25, 2023, and titled “METHOD AND SYSTEM FOR THE GENERATION, ADAPTIVE CONFIGURATION, AND PERSONALIZED DISPLAY OF TEXT AND VISUALS ON ELECTRONIC DEVICES,” which is incorporated by reference herein in its entirety.

### BACKGROUND

### 1. Field

Embodiments of the present invention generally relate to systems and methods for electronic content creation and display, and more specifically to the generation, adaptive configuration, and personalized display of text and visuals on electronic devices based on feedback provided to an adaptive content generator model.

### 2. Discussion of Related Art

Since the invention of the printing press, the content of documents and books have been fixed such that the words or images that a reader sees are pre-determined. In contrast, electronic devices may implement software that can change the information displayed when a viewer takes an action to request more content, such as when a user scrolls through a social media feed. Nonetheless, written works that are published electronically (including e-books, journal articles, blog posts, and more) retain the static and pre-set form of their paper predecessors—the text and visuals are the same for every reader, every time.

The static nature of written works can make them difficult for some readers to understand. For example, a book may use language or context that is above a reading level for the reader, causing the reader to become frustrated, or otherwise lose interest. In another example, the diagrams in a textbook utilized during a class may make sense to some students, but not others. In either case, the reader's experience with the static text and images in a work is a negative one, and may lead to the reader giving up on reading, learning, or otherwise engaging with the subject matter and material.

This is a fundamental challenge of publishing that a long history of modified works has attempted to address. Arguably the first written texts in human history were themselves abridgments or adaptations of stories from the oral tradition. Alterations to works have often been driven by the desire to increase the accessibility of the original material; for instance John Newbery's edition of the Bible, “adorned with Cuts for the Use of Children,” published in 1764, or the early nineteen-hundreds work “Gulliver's Travels, Retold for Little Folk” by Agnes Grozier Herbertson. As text production increased rapidly in the 1900s, the use of various types of synopsis grew as well, leading to Samuel Thurber's 1936 book “Précis Writing for American Schools: Methods of Abridging, Summarising, Condensing, with Copious Exercises”. Then, in 1950, Reader's Digest condensed-books club began publishing anthology volumes containing multiple abridged books combined into one convenient package. The success of Reader's Digest encouraged further experimentation with source-work-adaptations, extending all the way to contemporary digital consolidation services.

However, all such abridgments, summarizations, and modified versions maintain the same static information architecture and pre-determined state and form of works used since the printing-press. While the language and images may be different in the alternative versions from the original material they modify, the content they present is still pre-set, fixed, and the same for every reader. Thus, the same underlying issues described above persist despite the presence of prior products in the space: ‘one-size-fits-all’ written works are a fundamentally poor fit for the vast and diverse range of individual readers that may consume them.

These challenges, among others, are addressed by various aspects of the present disclosure as described in detail below.

### SUMMARY

In one aspect of this disclosure, a computer-implemented method for adaptive electronic content generation is provided. The method may include the operations of obtaining, at a processing device in communication with a tangible storage medium storing instructions that are executed by the processing device, a corpus of electronic documents associated with an instance of consumable electronic content, executing, by the processing device, a machine-learning model to generate an initial variation of the electronic content based on an initial consumption level of a user, the initial consumption level of the user based on information obtained from a user profile associated with the user, and receiving one or more inputs comprising at least one physical input to a computing system displaying the initial variation of the electronic content. The method may also include the operations of generating, by the machine-learning model, and based on the received one or more inputs, an adapted variation of the electronic content customized to a determined second consumption level of the user, receiving consumption data indicating a user's interactions with the computing system during a consumption of the adapted variation of the electronic content, and altering, based on the received consumption data, at least one parameter of the machine-learning model, wherein the altered parameter causes the machine-learning model to generate an updated variation of the electronic content.

In another aspect of this disclosure, a system for adaptive display of electronic content is provided. The system may include a processor in communication with a tangible storage medium storing instructions. When those instructions are executed, the processor may obtain a corpus of electronic documents associated with an instance of consumable electronic content, display, on a display device of a computing device, an initial variation of the electronic content based on an initial consumption level associated with a user of the computing device, and receive, from the computing device, one or more inputs during an interaction with the initial variation of the electronic content. The processor may also, in response to the executed instructions, generate, by an adaptive machine-learning model, and based on the received one or more inputs, an adapted variation of the electronic content, the adapted variation of the electronic content customized to a determined consumption level of a consumer of the initial variation of the electronic content and display, on the display device, the adapted variation of the electronic content customized to the consumption level of the consumer.

In yet another aspect of this disclosure, a computer-implemented method may be provided. The method may include the operations of obtaining, at a processing device in communication with a tangible storage medium storing instructions that are executed by the processing device, a corpus of electronic documents associated with an instance of consumable electronic content and displaying, on a display device associated with the processing device, an initial variation of the electronic content based on an initial consumption level associated with a user of the computing device. The method may also include generating, by an adaptive machine-learning model, and based on the received one or more inputs at the processing device, an adapted variation of the electronic content customized to a determined consumption level of a consumer of the initial variation of the electronic content and displaying, on the display device, the adapted variation of the electronic content customized to the consumption level of the consumer.

### BRIEF DESCRIPTION OF THE DRAWINGS

FIG. 1 shows an example network environment that may implement various systems and methods discussed herein.

FIG. 2 is a schematic diagram illustrating a multiple level adaptive system for generating and providing adapted electronic content in accordance with one embodiment.

FIG. 3 is a schematic diagram illustrating multiple levels of adapted electronic content based on various consumers in accordance with one embodiment.

FIG. 4 is a schematic diagram that depicts the adaptive modification of content in a work over time, including in real time, in accordance with one embodiment.

FIG. 5 is a schematic design illustrating multiple adaptive visual configurations of electronic content based on various users in accordance with one embodiment.

FIG. 6 shows an example block diagram of a multi-level adaptive system platform.

FIG. 7 is a schematic diagram illustrating a sample content management platform that may be used by editors in the process of creating a corpus for an electronic work in accordance with one embodiment.

FIG. 8 is a schematic diagram illustrating an example system for generating a corpus of an electronic work for an adaptive system in accordance with one embodiment.

FIG. 9 is a flowchart of a method for providing adapted electronic content from a multi-level adaptive system in accordance with one embodiment.

FIG. 10 is a schematic diagram illustrating the generation of multiple instantiations of adapted electronic content from a global corpus in accordance with one embodiment.

FIG. 11 is a block diagram illustrating an example data flow for updating an adaptation model utilizing machine-learning techniques in accordance with one embodiment.

FIG. 12 is a diagram illustrating an example of a computing system which may be used in implementing embodiments of the present disclosure.

### DETAILED DESCRIPTION

Systems, devices, and methods are disclosed herein for the generation, adaptive configuration, and personalized display of text and visuals on electronic devices. In one example, the multi-level adaptive system may determine and present a configuration of text and visuals that is customized for a specific user's capacity, interests, and needs when a user, or “reader”, ‘flips’ a digital page, clicks or presses a key to advance, gestures to move forward, or takes any other physical action to reveal more material in a digital work displayed on an electronic device. Put differently, an embodiment of the invention adapts an electronic presentation in real-time so that the graphics, language (words, sentences, paragraphs etc.), and overall structure of the work becomes dynamic and responsive to the context of individual users, rather than operating as a static object. Over the course of a longer content piece, one embodiment of the invention might gradually present a reader with a version, or instantiation, of the source material that no one else has ever seen before in an adaptive manner customized to the user's circumstances.

As an illustrative example, imagine a close friend asks you to read their recently published book. You might want to fulfill their request, but feel daunted by the prospect of the time and attention that will be required. To save time, you could physically scan through the book, or attempt to generate an automated summary. However, those techniques could limit your understanding of the material, may compromise your experience of engaging with it, and might be transparent and dissatisfactory to your friend.

Embodiments of the present disclosure may aid in this circumstance. Assume the book in question is 320 pages in length on the history of the Principality of Sealand. A starting goal as a reader, conveyed through initial inputs to an embodiment of the present disclosure, is to cut the time commitment in half by consuming a modified version of the work in approximately 160 pages worth of total content. Embodiments of the present disclosure may take a number of technical steps, described in detail below, to adapt the original work authored by your friend and personalize the content provided to you the reader. For instance, in a first instantiation or adaptation of the original material, the book's Foreword section might be summarized into a short paragraph by an embodiment of the present disclosure, as other elements of the text that are deemed redundant or of low interest are also seamlessly eliminated or combined.

As you begin to read, an embodiment of the present disclosure may continue to adaptively modify the work, in real-time, based on both implicit and explicit inputs provided by you as a user, and perhaps from other readers or systems. For example, an embodiment of the present disclosure might prioritize presenting the personal stories and photos of the author that are included throughout the book because you, the reader, have a personal connection to them (in contrast to another hypothetical reader focused on the historical details of Sealand, for whom an embodiment of the invention might cut these passages entirely). Preserving your bandwidth as the reader for the author's stories and photos may require an embodiment of the present disclosure to continuously make corresponding modifications to other material in the original work based on your overall reading pace. Ultimately, you might finish a final 20 “pages” of the book the night before seeing your friend again, for a total of just 140 pages consumed. But, thanks to an embodiment of the present disclosure, those 140 pages comprised the most relevant and interesting content to you, specifically from the complete body of the original work.

In summary, an embodiment of the present disclosure has presented the reader or consumer, through technical methods and systems described in greater detail below, with a ‘personal’ version of your friend's book-one that balances and melds the author's intent and efforts with the reader's individual interests and constraints as a consumer.

In one particular example, delivering personalized text and visuals on electronic devices may entail three technology system components: a machine-learning or an artificial intelligent (AI) platform; a display program, and a computing device comprising a display. The artificial intelligence platform may include one or more of a large language model (LLM), natural language processing (NLP) platform, text-to-image generator, or various other artificial intelligence technologies. In general, the AI platform may ingest a vast range of source materials (for instance books that are made up of a combination of text and visuals) to form a global corpus for a particular work to be displayed. The AI platform may also train on and learn from human engagement and decision making in a multiple-level adaptive process, and participate actively in the generation of such adaptive content by generating variations and configurations of source material that can either be presented directly to users or manually selected, edited, discarded, or otherwise altered by collaborators in order to help create adapted works. The AI platform may also manage the personalized display of information or content for individual users as instantiations of adapted works based on a number of different data sources and physical inputs. For example, data may be provided by end users of adapted works via physical interaction with an input component of an electronic device on which the adapted work is displayed. Data may also be submitted directly to the AI platform via a user platform or administrative dashboard in the form of settings, preferences, parameters, or other data sources or instructions to help inform the adaptive process which generates custom text and visuals for individual users as they progress through an instantiation of an adapted work, either automatically or on request. Text in the context of an adapted work may include configurations of tokens, words, sentences, paragraphs, pages, chapters, etc. The text of the adapted work may also include summaries of portions of the written work using other words or phrases. Visuals include a large range of media or display techniques including, but not limited to, videos, images (illustrations, diagrams, etc), formatting (bold, italics, underlines, etc.), highlighting, accent marks, definitions, annotations, and other forms of graphics that convey information within a work.

Each of the components described above are described in greater technical detail below. In one example, an embodiment of the present disclosure might customize the formatting of works for a user suffering from vision loss. Vision challenges can take many unique forms, some of which may persist over time, and some of which may be temporary. An embodiment of the present disclosure may thus incorporate medical diagnoses, user preferences, and other forms of data as initial inputs when presenting a work in adaptive fashion. An embodiment of the present disclosure may also employ highlighting, animation, or other forms of visual emphasis such as changing background and text colors to personalize the reading experience of a work for a user, in addition to modifying the language in real-time. Over the course of a reading session, an embodiment of the present disclosure might gradually increase the size of the text to reduce the strain on a user's eyes. Camera or other sensor data may be used to continuously or intermittently to detect eye status or other types of indicators or inputs in order to inform the functioning of disclosed systems.

As noted above, the multi-level adaptive system may include a generation and display program configured to generate a user interface for the display of adapted work instantiations which receives and executes dynamic configuration instructions for the presentation of text and visuals from the artificial intelligence platform. The system may also include a hardware device that executes the frontend software display program, and/or collects a variety of data which is provided to the artificial intelligence platform as inputs. This data may include, but is not limited to, inputs provided through the hardware device, including both explicit and implicit user actions. Explicit user actions may include any user-initiated request to receive a modified variation or adaptation of the source work from the system. For instance, a user might click a button, provide verbal or written instructions to a program, toggle certain software functionality on or off, set filters, use sliders to control the intensity or weighting of certain parameters, or take other explicit actions as input to the system. Such explicit actions may be provided through one or more input devices of a computing device, and transmitted or otherwise obtained by the adaptive system. Implicit user actions or signals may include touches on the display device by the user, a determined average viewing velocity of the user, a time interval between activations of the computing device, an indication of backwards movement in a written work by the user, camera-based eye tracking to understand engagement with the device, and other uses of sensors and types of physical evidence about a user that can be collected tacitly, or in the background of computing usage, by a digital device. Implicit actions may similarly be received through the one or more input devices and/or may be obtained from one or more sensors configured to obtain information of actions or states of a consumer of the adapted work. In general, any data that informs the operation and adaptive functions of the entire technology system may be provided to the AI platform, as described in more detail below. Some inputs may be tacitly collected and some may be explicitly provided by users—for example, a request via a button to see a visual depiction of a written scene.

In one embodiment, sensors in communication with, or embodied within, digital devices may measure and respond to the physical presence and expression of a user's attention. For example, a reader may use their hands, eyes, and other body parts to move and reconfigure the words, formatting, and structure of displayed content as they progress through it. The sensors are therefore configured to obtain or determine a physical reaction of a user on a real-time basis through both intentional and unintentional inputs that are collected by the sensors. As such, the systems and methods described herein may determine, in real-time, the engagement of a consumer and utilize the detected engagement to adapt the content over time.

In one example, physical inputs of a consumer may indicate that a reader is more likely to pause or end a reading session when the content being presented is more descriptive and abstract. This data can then be incorporated into the functioning of the adaptive system. As described in greater technical detail below, an embodiment of the present disclosure may store such information in a user profile to personalize multiple different works for an individual user and other users.

In summary, instead of providing every reader or consumer with the same information consumption experience, such as a typical written work, the present disclosure may allow users to configure their own ideal reading or learning environment. In turn, the data provided by individual users, both within a session and over time, can bolster the performance of present disclosure for all users

In addition to the components described above, the multi-level adaptive system enables manual contribution of content and direction to an embodiment of the system in order to successfully deliver personalized text and visuals to individual users. For instance, the system provides for the creative adaptation of a work multiple times at different complexity levels. This process produces a corpus of words, phrases, visuals, and structures, or versions, that an artificial intelligence platform can draw upon, and also contribute to, in order to adaptively configure and display personalized instantiations of an adapted work to consumers.

For additional context, one of the limitations of existing AI systems is that they pay equal attention to all of the tokens in their context window regardless of their significance. An embodiment of the present disclosure allows for the structuring of the corpus associated with any individual work in ways that create efficiencies, improve quality, and reduce redundant processes when adaptively configuring the corpus and displaying a personalized instantiation for individual users. For instance, an editing system may ‘lock’ or protect specific tokens—such as the line “it was the best of times, it was the worst of times”—within a work to ensure that those tokens are always presented in their original source form. This contribution of content and direction by an editing system creates further structure and clarity of subject matter within the corpus associated with a work that helps the adaptive model described in greater detail below function efficiently for a consumer.

Through the methods and systems described herein, user input may be fed back to the multi-level adaptive system (and in particular, the AI platform of the system) to develop a virtuous cycle of usage, data collection, and continuous refinement of digital content. In some embodiments, the system may parse a document or other digital work and automatically generate a multi-level adapted work containing multiple unique configurations of the source material for different types of consumers without assistance or contribution from users or facilitators. In other instances, a facilitator system or device may be utilized to aid in generating a corpus of the digital work from which the adapted work is then generated.

For instance, imagine an internal corporate memo written by a chief executive officer that is intended for distribution throughout a large multi-\national company with a wide range of employees. An embodiment of the present disclosure may adapt the original memo by automatically creating multiple unique configurations that are customized for different workplace personas, such as executives, senior leaders, middle managers, corporate staff, front line workers, etc. These modified configurations, or versions, could be further augmented by an embodiment of the present disclosure through a facilitator system which might attach additional corporate content or context not included in the original written piece that may nonetheless be relevant. Together, the automatically generated configurations and additional included content may comprise a corpus which significantly expands the capabilities, complexity, and robustness of the initial memo.

To further extend the example, an individual front-line worker who receives the initial configuration of the memo intended for their persona may indicate a preference to also see, or be exposed to, the versions of the memo intended for middle managers and senior leaders as an opportunity to learn. In response, an embodiment of the present disclosure might adaptively substitute specific phrases, paragraphs, or other information in the corpus that challenge the employee to grapple with new and more complex concepts that relate to the company strategy, and support their personal career growth.

Through the production of training data and a corpus of lexical and graphical material for the artificial intelligence platform, an embodiment of the present disclosure creates an environment for the custom configuration of a work to be produced through a method of algorithmically processing and digitally conveying to the frontend software program text and visuals that are viewed and engaged with by a user on a hardware device. Users' engagement with the modified work provides additional data and physical inputs that prompt the artificial intelligence platform to further refine and adaptively configure the instantiation of the material being presented via the software and hardware to individual users. In this manner, the present disclosure provides a multi-level adaptive system that effectively delivers personalized text and visuals in the form of electronic adaptive content. The potential benefits of the present disclosure for literacy and the overarching societal delivery of information are immense.

For example, consider a government white paper or report on the state of the economy. Such a work may be long and complex in its original published form, preventing a wider set of people from engaging with the content and understanding its importance. The systems and methods described herein may transform the source material into electronic content that is presented adaptively and becomes more accessible to users who might otherwise be overwhelmed by the intricacies of the work.

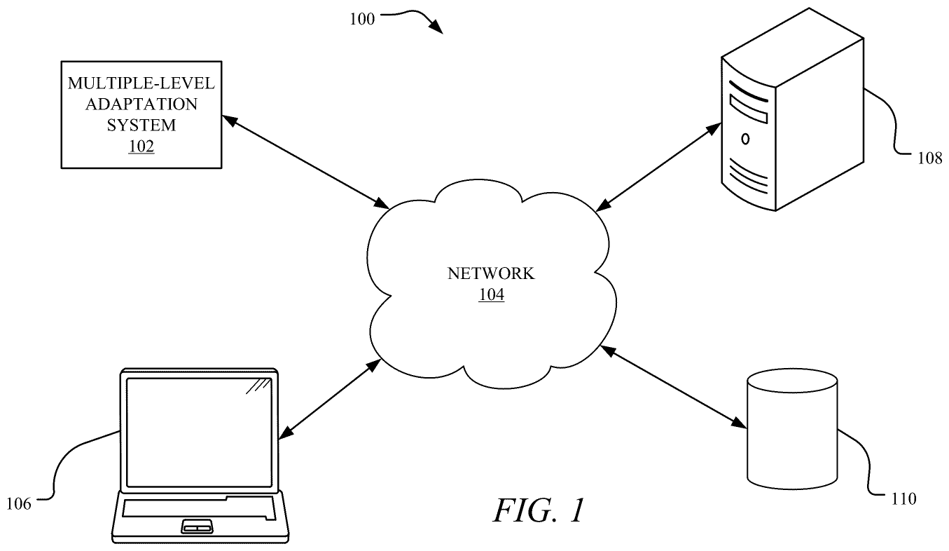

To begin a detailed discussion of an example reservoir depletion assessment system, reference is made to FIG. 1. In particular, FIG. 1 illustrates an example network environment 100 for implementing the various systems and methods as described herein. As depicted, a network 104 is used by one or more computing or data storage devices for implementing the systems and methods for a multiple level adaptive (MLA) system 102 for creative adaptation of a digital work as part of the process of forming a corpus that can be presented in personalized fashion to individual users. In one implementation, various components of the MLA system 102, one or more user devices 106, one or more databases 110, and/or other network components or computing devices described herein are communicatively connected to the network 104. Examples of the user devices 106 include a terminal, personal computer, a smart-phone, a tablet, a mobile computer, a workstation, and/or the like.

In some instances, components of the network environment 100 of FIG. 1 may be combined. For example, the MLA system 102 may be executed directly by user devices 106. More particularly, the MLA system 102 may be downloaded to the user device 106 via network 104 and executed on the device. Other aspects of the network environment 100 may also be downloaded to the user device and executed to perform the steps and functions described herein, in some cases without an internet connection or other connection to the network 104. In such circumstances, a specific MLA work or multiple MLA works from the MLA system 102 may be provided to the user device 106 that each contain a corpus and an adaptive model which can run locally to personalize the display of text and visuals on the device hardware without requiring a connection to a server 108 or databases 110.

A server 108 may, in some instances, host the system 102. In one implementation, the server 108 also hosts a website or an application that users may visit to access the network environment 100, including the MLA system 102. In another example, the server 108 may be a central server hosting the MLA system 102, or one or more components of the MLA system to receive data from multiple users of the MLA system. The server 108 may be one single server, a plurality of servers with each such server being a physical server or a virtual machine, or a collection of both physical servers and virtual machines. In another implementation, a cloud hosts one or more components of the system. The MLA system 102, the user devices 106, the server 108, and other resources connected to the network 104 may access one or more additional servers for access to one or more websites, applications, web services interfaces, etc. that are used for the method described herein.

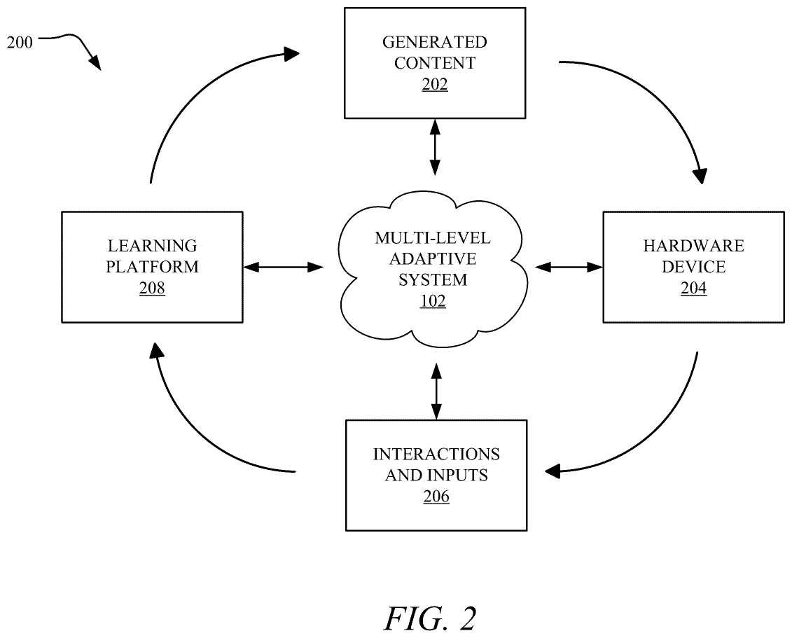

FIG. 2 illustrates a multiple level adaptive system environment 200 for generating and providing adapted electronic content in accordance with one embodiment. As described above, the MLA system 102 may operate in a cyclical manner to automatically and spontaneously adapt electronic content based on feedback data and other inputs. As illustrated in the network environment 200 of FIG. 2, the MLA system 102 may interact with a learning platform 208 (which in some cases may be an AI-based model), generated content 202 in the form of an executable software application, and one or more computing devices 204. Initially, generated electronic content 202 may be determined by the MLA system 102 and provided as an executable software program 202. The electronic content 202 is displayed on a computing device 204 such that a user may consume the electronic content. For example, an electronic book with a plurality of pages of text may be displayed on the computing device 204 for reading by a user of the computing device. In another example, an electronic magazine with text, links, and/or images may be displayed on the computing device 204 for viewing by a user of the device. In general, any text, images, or combination thereof may be included in the electronic content and displayed on the computing device 204 through a corresponding software program or application.

Before, during, or after consumption of the electronic content 202, interactions and/or other inputs 206 may be provided to the MLA system 102 for use in adapting the electronic content in response to the interactions and/or inputs. For example, interactions of the user with the computing device 204 may be tracked or otherwise captured by the device. The interactions may include active interactions with the computing device 204 by the user (e.g., touches on the screen, highlighting of text, signals received from an input device to interact with the text directly) and passive interactions (e.g., average viewing velocity, intervals between sessions, backwards movement in a work, etc.). In addition to interactions during consumption of the electronic content 202, the MLA system 102 may also obtain inputs 206 before or after the consumption of the electronic content. For example, a user to the MLA system 102 may provide an indication of a reading level of the user or another user of the system prior to consuming the electronic content 202. In another example, the MLA system 102 may receive feedback of the user's experience of the consumption of the electronic content 202. For example, the user may provide an input to the MLA system 102, perhaps as an input via the electronic device 204, to indicate to the system that the adapted work 202 was too hard or too easy to consume. In one instance, the MLA system 102 may display a questionnaire on the screen of the computing device 204 prompting the user to provide their feedback on the user's experience with the adapted content.

To provide a single comprehensive example, a parent might provide an input requesting a certain initial level of complexity to the MLA system 102 through a dashboard or administrative interface before their child begins reading a story. As the child reads, their inputs 206 collected during the use of the computing device 204 may inform the functioning of the MLA system 102 to further customize the content 202 of the work in real-time. Then, once the child has finished the story, the MLA system 102 may display a report and accompanying questionnaire to both the child and parent, either together or separately, to collect additional inputs 206 to support the ongoing functioning of an embodiment of the invention.

The interactions and/or inputs 206 obtained by the MLA system 102 may be provided to, or otherwise used by, the learning platform 208 for altering the electronic content 202 based on the received interactions and/or inputs 206. For example, the MLA system 102 may adapt the electronic content to be of a higher or lower reading level based on the interactions and inputs. If the interactions with the electronic content 202 indicates, as determined by the learning platform 208, that the consumer is struggling to comprehend the electronic content, the MLA system 102 and/or the learning platform may generate adapted content corresponding to the determination of the user's consumption. The adaptation of the electronic content 202 may occur at different timeframes. For example, the learning platform 208 may generate an adapted content based on the user interactions 206 and present the adapted content to the user when the user next interacts with the computing device 204 or electronic content 202. In another example, the MLA system 102 may generate and present adapted content 202 in real-time or otherwise while the user is consuming the content. In this manner, the MLA system 102 may alter electronic content 202 in response to the interactions and inputs as the user is consuming the electronic content through the computing device 204.

For instance, consider a person trying to learn French for the first time. One embodiment of the MLA system 102 may provide an initial instantiation of electronic content 202 in a user's native language, with just a few French words strategically sprinkled in. As a user reads, the balance of languages used in the electronic content 202 may be adjusted in real time depending on the user's physical inputs 206 and progression through the work. By the end of the piece, the MLA system 102 may have increased the frequency of French in the content 202 significantly as the user continually puzzles out the meaning of various words based on their context.

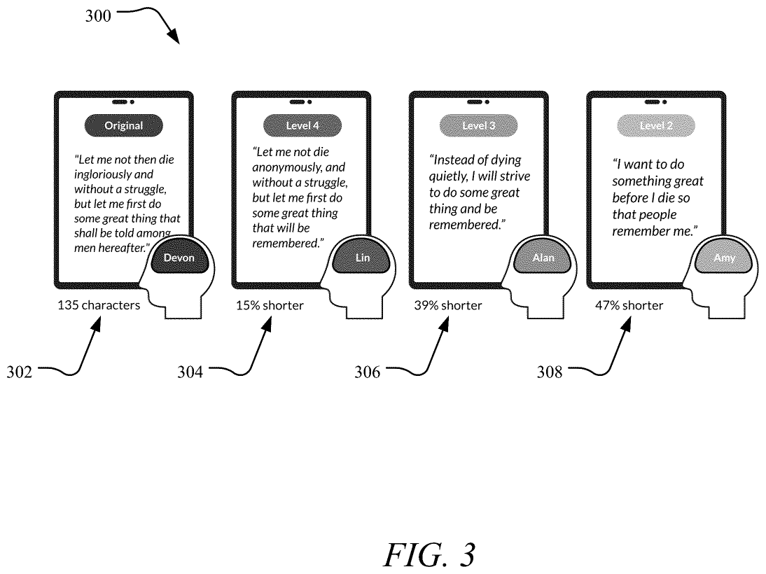

FIG. 3 is a schematic diagram 300 illustrating multiple levels of adapted electronic content based on various consumers in accordance with one embodiment. The electronic content may be generated through the process illustrated and discussed with reference to FIG. 2 above. Further, the electronic content illustrated in FIG. 3 is one example of the type of electronic content that may be generated through the MLA system 102 described herein. Thus, although reference is made to an adaptive text in the examples illustrated in FIG. 3, it should be appreciated that the adapted electronic content may include other displayed content, such as images, movies, links, highlights, footnotes, or any other content that may be displayed on a computing device.

As described above, the MLA system 102 may adapt electronic content prior to or during consumption of the content by a user via a computing device. One example may include adapting a book or other written text. The adaptation of the content may be based on a determined reading level or other capability of the consumer. For example, the MLA system 102 may determine that a first user 302 is capable of consuming the original text of the work. This determination may be based on the interactions and/or inputs provided to the MLA system 102 from the user, or during consumption of the content by the user, and may or may not change as the user continues to consume the work. In other words, the MLA system 102 may determine that the first user 302 is capable of understanding or consuming the electronic content as written, with little or no adaptation. In contrast, the MLA system 102 may determine that a second user 304 has less capacity for ingesting the written work in its original form. For example, the MLA system 102 may determine that the second user 304 may benefit in consuming the content through an instantiation, or version, of the text that uses simpler vocabulary, shorter passages, different sentence structure, more modern terminology, and other such modifications that may aid the second user in understanding the electronic work. The MLA system 102 may then generate an adapted electronic work corresponding to the determined consumption level of the second user 304. In this example, the electronic content provided to the second user 304 may be 15% shorter than the content provided to the first user 302 such that the adapted content may modify one or more words from the content that may be difficult for the second user to understand. Although FIG. 3 is illustrated as adapting the electronic content to be shorter or include fewer words, it should be appreciated that the adaptation of the electronic content may include many types of modifications, including but not limited to replacing words with similarly-meaning words, altering sentence structure, generating new paragraphs, sentences, or words for easier understanding, adding or removing an image to aid in understanding, and the like. Some adaptive changes implemented by the MLA system 102 may add to the length of a work or passage, and/or introduce additional content that was not included in the original work. In general, the electronic content may be altered in any manner in response to the determination of the consumption level of the user.

In a similar manner as above, a third user 306 may be presented with a third configuration of adapted electronic content and a fourth user 308 may be presented with a fourth adapted electronic content. As explained in more detail below, the various adapted content provided to different users by the MLA system 102 is based on a corpus of electronic content from which the adapted content is generated. The adapted works may provide the same intent or meaning as an original work, but be tailored or adapted to a determined understanding level of the consumer. Further, the adaptation may be provided in real-time to the user as the user interacts with the adapted electronic content to aid in the user understanding the content. In essence, the MLA system 102 may transform the digital presentation of text and visuals from a fixed act of reproducing source material verbatim into an active and ongoing process of personalizing and configuring custom instantiations of the work that balance the intent, language, and formatting of the original source tokens with the unique capacities, needs, interests, and goals of individual consumers.

For example, the MLA system 102 may monitor, or otherwise determine, a pace at which a user is consuming the generated electronic content and adjust the content accordingly. If the user is consuming the content at a rate below a threshold value, the electronic content may be adjusted to be shorter, use easier to understand vocabulary, include more visuals or images with the text content, or other such strategies. If the user is consuming the content at a rate above a threshold value, the electronic content may be adjusted in the other direction to provide a higher-level of content. In general, the MLA system 102 may monitor any interactions or feedback from the user while using the computing device to adjust the electronic content in real-time. Further, the content may be adjusted in any manner in response to the received interactions or inputs associated with the consumer of the content.

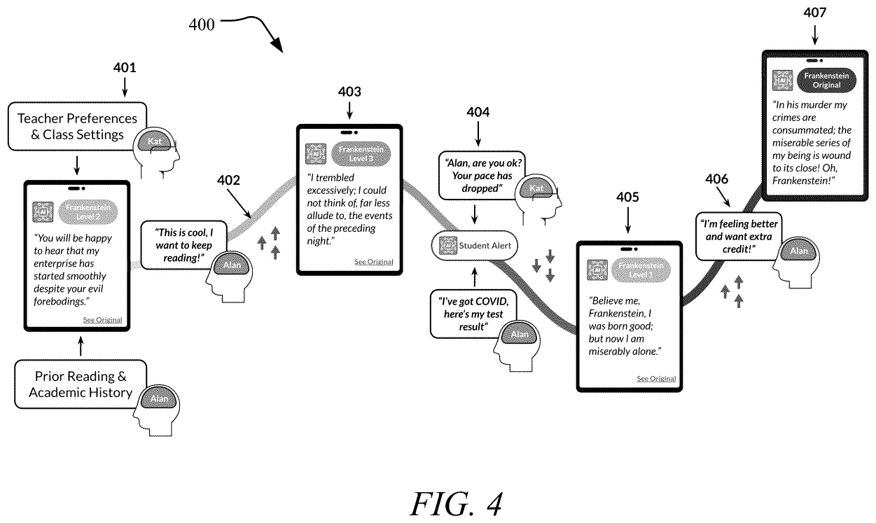

FIG. 4 is a schematic diagram 400 that depicts the MLA system 102 operating over the course of time, including adaptively modifying the content presented to a user in real time. In this instance, the user may start at a complexity level 2 determined by multiple inputs 401, including their prior reading and academic history and their teacher's preferences and class settings. Based on the user's engagement with the work, along with other forms of physical inputs, the MLA system 102 may begin to gradually increase the complexity of the work 402 presented to the user in real-time. Soon, the user may be reading at a full level higher than when they started 403. But, their momentum also may begin to flatline 403 due to the increased difficulty of the text and as determined through a variety of physical or passive inputs described in detail above and below. The MLA system 102 may then begin to reduce the complexity of the work in response to further inputs, including the documented medical status of the student 404, eventually presenting the user with Level 1 language 405. While the user may now be consuming a significantly simplified version of the original work 405, they may also still read and engage with the material and subject matter, instead of having quit reading altogether. By the close of the book the MLA system 102 may support the user in reading some or all of the final few pages in their original form 407.

FIG. 4 helps demonstrate how MLA system 102 personalizes the experience of consuming a work. The information that is adaptively displayed to the user by the MLA system 102 is optimized for the user's context, capabilities, needs, interest and goals from the first instantiation of the work 401 to the last 407, and at every point in-between 402, 403, 404, 405, 406. While this diagram identifies seven key moments in the user's course through the work (401-407), the MLA system 102 may be functioning adaptively continuously throughout the user's engagement with the text, implementing hundreds, thousands, or even tens of thousands of modifications to the electronic content in support of the user. The MLA system 102 may modify or adapt any aspect of the language and structure of the work including visuals such as images (illustrations, diagrams, etc.), formatting (bold, italics, underlines, etc.), and other forms of graphics that convey information within a work.

For example, by clicking to enable a ‘comparison mode’ users might see multiple different versions of the same sentence presented at once to reveal different configurations, or levels, of the same source material. Even more simply, a user consuming a modified instantiation of an electronic work might click to see a visual presentation of the original material developed by the author. Any such techniques that may support the comprehension and engagement of users with a written work may be employed as part of the MLA system 102.

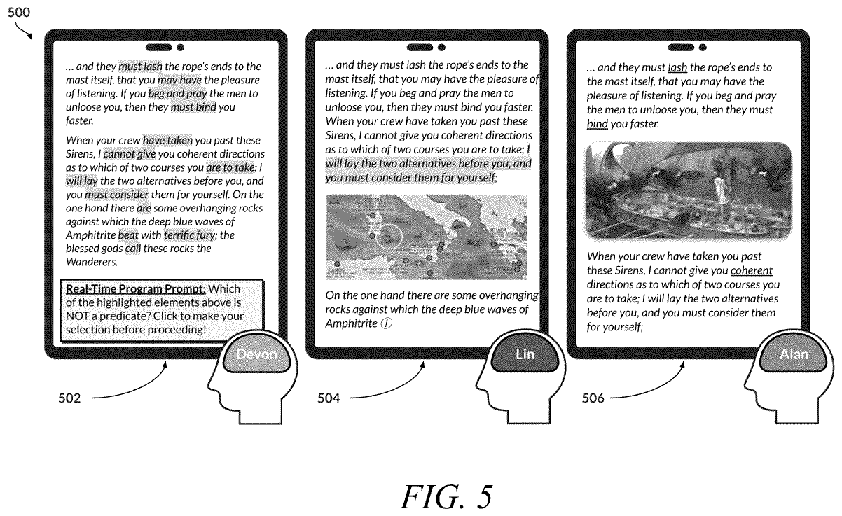

FIG. 5 is a schematic design 500 illustrating multiple visual configurations of electronic content based on the unique capacities, needs, interests, and goals of various users in accordance with one embodiment. In this instance, while the text that each consumer is seeing is the same, the visuals, formatting, and other graphical elements of the work displayed by the MLA system 102 are personalized for each reader. The electronic content illustrated in FIG. 5 is one example of the type of electronic content that may be generated through the MLA system 102 described herein, and it should be appreciated that the adapted electronic content may include other displayed content such as movies, links, footnotes, or any other graphical or visual content that may be displayed on a computing device.

In this instance, the MLA system 102 may determine that a first user 502 prefers a smaller text size and no images when reading a work. In addition to incorporating this data into the resulting configuration of an instantiation of the work, the MLA system 102 may receive an input from an administrator-such as a teacher using a dashboard that may be provided as part of the MLA system-requesting that an embodiment of the invention help provide remedial support for the user 502 regarding grammatical structures. In response, the MLA system 102 may highlight all of the predicates in a text for the first user 502 as part of the personalized configuration of an instantiation of the work. Additional adaptive functionality combining both visuals and languages may also be incorporated into the presentation of the electronic content by the MLA system 102 on behalf of user 502, for instance in the form of quizzes or other types of assessments that may be automatically generated to collect inputs which inform the continued adaptation and display of the work. For example, the user 502 might be prompted by the MLA system 102 to identify the incorrect example of a highlighted predicate on the page as shown in FIG. 5, or otherwise demonstrate knowledge or comprehension in any other manner. In this fashion, MLA system 102 may spontaneously leverage its adaptive language and visual capabilities to display and collect additional inputs from a user 502 that help further refine the functioning of the MLA system 102 for the user's, and other users', benefit.

It should be appreciated that the configuration and display of graphics and language to generate an input collection mechanism to a user 502, completely at the initiative and self-determined timing of the MLA system 102 without any external intervention, represents the capability of the MLA system to improve its own functioning for both individual users and all users of the system adaptively and in real-time. Technical details above and below further describe the capacity of the MLA system 102 to generate and present spontaneous input collection mechanisms as part of the ongoing functioning of the MLA system 102 in the course of personalizing an instantiation of a work for a user. A user's response to the prompts, quizzes, assessments, or other input-collection mechanisms proffered by the MLA system 102 may also be stored in their personal profile, and act as data employed by the MLA system 102 when it is utilized by the user in the future.

To return to FIG. 5, the MLA system 102 may determine that a second user 504 prefers reading slightly larger text and is interested in understanding the geography and movements of the characters in the work in question. Incorporating this input into the adaptive display of an instantiation of the work for user 504, the MLA system 102 may highlight moments where navigational choices are being made. The MLA system 102 may also present maps or other forms of graphics or visuals to the user 504 when the MLA system 102 deems it appropriate to do so, along with providing optional information or additional context regarding places or geographic features such as the “Amphitrite”. It should be appreciated that these graphics and adaptive configurations relevant to locations may be specifically customized for user 504, and distinguished from the instantiations and display of the work by the MLA system 102 in FIG. 5 for users 502 and 506, both of whom provide different inputs to the MLA system 102. This personalized visual configuration of the work may be based on the interactions and/or inputs provided to the MLA system 102 from the user, or during consumption of the content by the user, or based on a personal profile for the user, and may or may not change as the user continues to consume the work.

In a similar manner as above, the MLA system 102 may present a work to the user 506 with a larger font size, and may adaptively underline key vocabulary words in the text that the user can click on to be reminded of their definition. In addition to dynamically formatting the language of a work for the user 506, the MLA system 102 may automatically or spontaneously present a visual depiction of the scene described by the work. The user 506 may be able to provide inputs or control different parameters of the MLA system 102 regarding image-generation executed by the MLA system 102 within an instantiation of a work. For example, a user 506 might enable a setting to always see images accompanying key moments in a work as determined by the MLA system 102. Or, a user 506 might request a certain style of visual depiction, whether illustrated, black-and-white, or through any other input that may inform the MLA system 102.

In summary, FIG. 5 conveys how the MLA system 102 may personalize and adaptively mutate the visual presentation of a work for individual users, in addition to modifying and configuring the text of a work in real-time. While the form of a book is presented in FIG. 5, any type of work or electronic content may be configured in personalized instantiations by the MLA system 102. Further methods and aspects of the MLA system 102 are explained in more detail below.

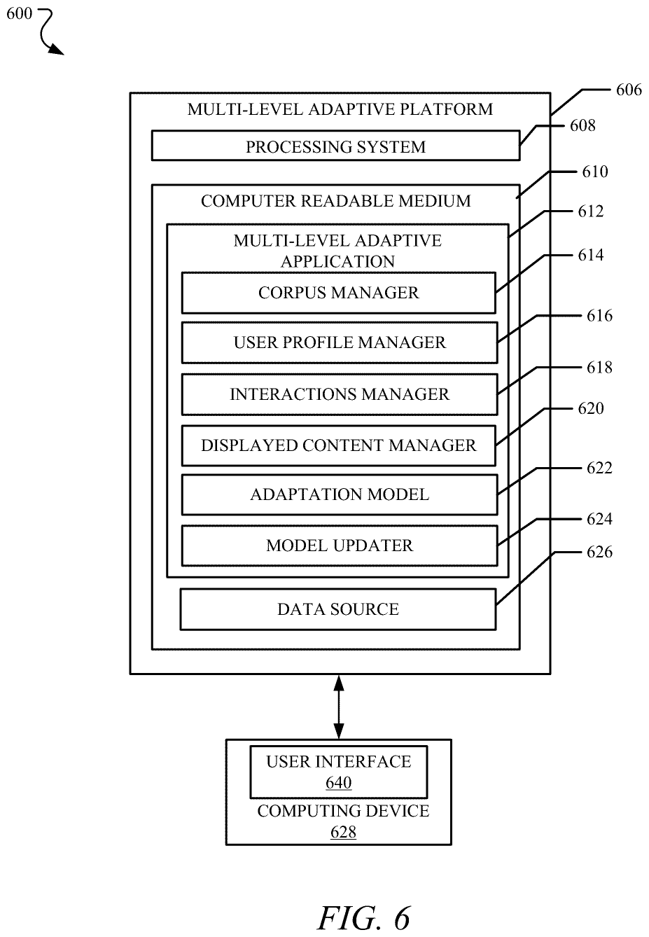

FIG. 6 shows an example block diagram of a multi-level adaptive (MLA) system platform according to embodiments disclosed herein. In general, the system 600 may include an MLA platform 606. In one implementation, the MLA platform 606 may be a part of the MLA system 102 of FIG. 1. As shown in FIG. 6, the MLA platform 606 may be in communication with a computing device 628 providing a user interface 640. As explained in more detail below, the MLA platform 606 may be accessible to various users to interact with and/or consume electronic content displayed via the user interface 640. For example, access to the MLA platform 606 may occur through the user interface 640 executed on the computing device 628. For instance, one implementation may comprise a mobile application used on a smartphone or tablet to read books, articles, and other types of electronic content.

The MLA platform 606 may include an MLA application 612 executed to perform one or more of the operations described herein. The MLA application 612 may be stored in a computer readable media 610 (e.g., memory) and executed on a processing system 608 of the MLA platform 606 or other type of computing system, such as that described below. For example, the MLA application 612 may include instructions that may be executed in an operating system environment, such as a Microsoft Windows™ operating system, a Linux operating system, a UNIX operating system environment, or other such operating system. By way of example and not limitation, non-transitory computer readable medium 610 comprises computer storage media, such as non-transient storage memory, volatile media, nonvolatile media, removable media, and/or non-removable media implemented in a method or technology for storage of information, such as computer readable instructions, data structures, program modules, or other data.

For example, one embodiment may be embedded at the level of an operating system in order to facilitate the reading and information consumption habits of users of the operating system. By ingesting signals and data across an individual's engagement with electronic content and information on a device, or multiple devices, the embodiment may form a refined personal profile for a user, as described in greater technical detail below. This personal profile may then be used by the MLA system 102 functioning as part of an operating system, or in tandem with an operating system, to customize all or some of the written works or electronic content that a user consumes on their device(s).

When a user loads an article, or an ebook, or any other form of a work for consumption on a computing device 628, the MLA system 102 may ingest the source material, form a corresponding corpus, and customize the information that is displayed on the screen for the user, including the language of the piece, the text size, images, background formatting, and other elements based on the unique capacities, needs, interests, and goals of the user. The electronic content may then be further personalized through the ongoing adaptive functioning of the MLA system 102.

The MLA application 612 may also utilize a data source 626 of the computer readable media 610 for storage of data and information associated with the MLA platform 606. For example, the MLA application 612 may store a corpus of electronic content, including the original text and/or images, alternative text and/or images, various threshold values for adapting the electronic content, user data, one or more machine-learning or artificial intelligent models, and the like. As described in more detail below, such data may be stored and accessed via the user interface 640 for the MLA platform 606. For instance, the MLA platform 606 may build a corpus that is specific to a long legal article which also includes relevant case-law, reference material, and imagery or visual exhibits. This corpus, along with an artificial intelligence model, might be downloaded to a user's device 628 for offline usage. The MLA system 102 may still function in all of the ways described in this document in this scenario, with the corpus being adaptively configured by the adaptation model 622 both initially, and in real-time thereafter, for consumption by the reader.

The MLA application 612 may include several components to adapt electronic content for consumption by a user of the application and/or computing device 628. For example, the MLA application 612 may include a corpus manager 614 component. The corpus manager 614 may perform several functions for the MLA application 612, including but not limited to, obtaining an original electronic content, obtaining or generating one or more additional electronic content associated with the original electronic content, and associating the original and the additional electronic content as a corpus of content for an adaptive electronic content. For example, the corpus for an electronic work may include the original text and images of a book, such as a novel or textbook. In addition, alternate text and images may be included in the corpus, such as similar meaning words or phrases to words or phrases in the original text, alternate sentences or passages, alternate images to illustrate the text of the electronic work, and the like. In general, any number and types of alternate content may be included in the corpus of the electronic work. In some implementations, the alternate content may be generated by an editor and provided to the corpus manager 614 for association with the original content. In other implementations, the alternate content may be generated by a computing device, system, machine-learning program, or other application configured to generate alternate content for the corpus of the electronic work.

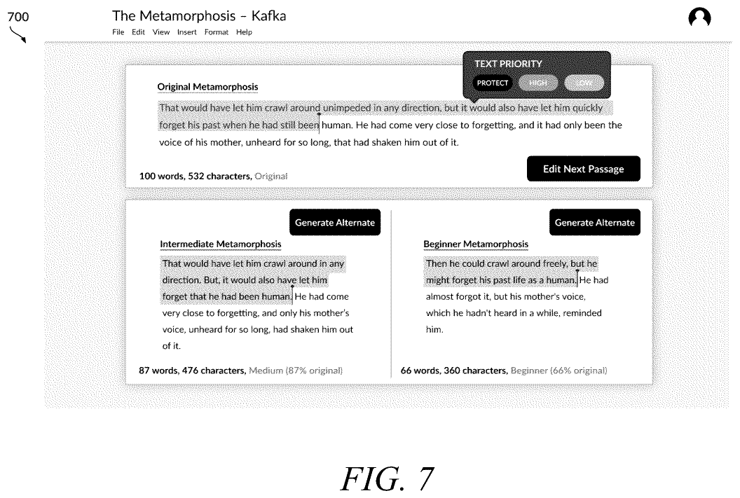

FIG. 7 is a schematic diagram illustrating a sample content management platform 700 that may be used by an editing system in the process of creating a corpus for an electronic work. It should be appreciated that while multiple versions of a work are shown separately in the content management platform 700, each of these versions may be integrated into a single corpus to be provided to the corpus manager 614 for adaptive presentation of a work to a user by the MLA system 102. In addition to editing or managing versions, the content management platform 700 may support the contribution of other types of electronic content, such as priority specifications or other types of alternate content. The content management platform 700 may incorporate actions by both an editor and a computing device, system, machine-learning program, or other application that may contribute to the process of creating a corpus for an electronic work. Any actions and choices of editors or other contributors using the content management system platform 700 may be made within the purview of an artificial intelligence model that may learn from the employed approach to improve the functioning of the MLA system 102.

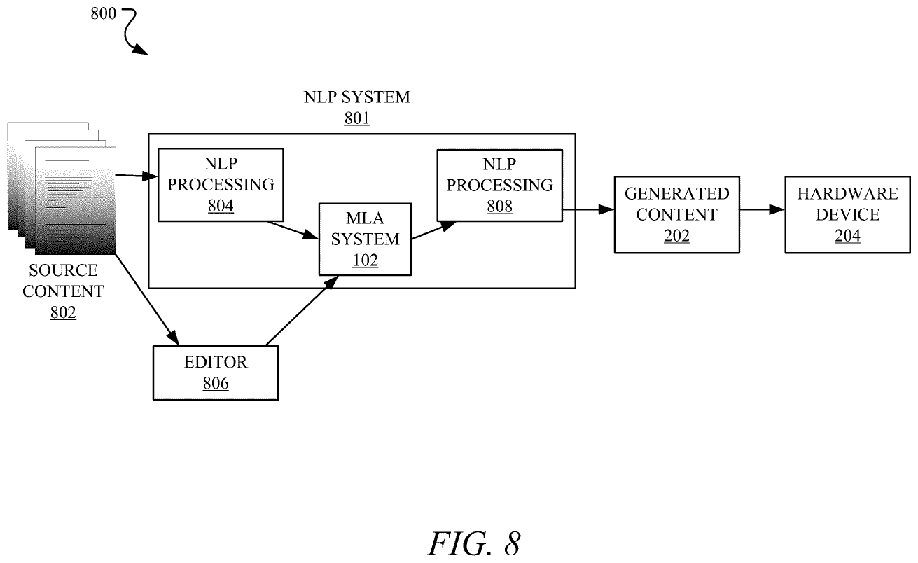

FIG. 8 is a schematic diagram illustrating an example system 800 for generating a corpus of an electronic work for an adaptive system in accordance with one embodiment. The system 800 may include several of the components discussed above, such an MLA system 102 and generated electronic content 202 for display on a hardware device 204. In this embodiment, however, the MLA system 102 may be a portion of a natural language processing (NLP) system 801. It should be appreciated that only a portion of the MLA system 102 may be included in the NLP system 801 and that other components/functionalities of the MLA system 102 may be separate from the NLP system 801.

As described above, the MLA system 102 may include a corpus manager 414 for managing a corpus of an original work. The corpus may include the original source content 802, such as a book, documents, images, etc. that consist of the original work. In addition, alternate content may also be incorporated and, in some cases, generated to be included in the corpus of the MLA system 102 for use in customizing and configuring the content 202 provided to the hardware device 204 through the methods described herein. The alternate content may be generated in several ways. In one example, an editor 806 (such as a human editor or an editor computing device) may use a content management platform 700 to process the source content 802 and generate the alternate content for inclusion with the MLA system 102.

In another implementation, the NLP system 801 may process (at NLP processing step 804) the source content 802 and generate the alternate content for the corpus. For example, the NLP system 801 may process the source content 802 to identify words, phrases, sentences, and the like and generate one or more alternatives with text of similar meaning. The NLP system 801 may also add useful content or context that relate to the work such that might be found in or form, a ‘penumbra’ of relevance to the original source material. The NLP system 801 may also associated various portions of the corpus with a skill level, complexity measure, or any form of tags, labels, identifiers, or categorization such that the MLA system 102 can adapt the original content based on determined preferences of the reader. In general, the NLP system 801 may aid in any way in generating a corpus comprising the original content 802 and alternative text and/or images for use in altering the original content for display on the computing device 204.

For example, an embodiment of the MLA system 102 may generate multiple versions of the original text at different reading levels. This iterative development of language may entail altered vocabulary, syntax structure, the complexity of the source subject matter, accessibility of abstract concepts, and more. At the same time, the system 102 may maintain some level of structural consistency between different versions of an MLA work existing within a corpus to ensure that dialogue, page numbers, and other elements like chapters are shared across every version, and/or personalized instantiation, of the source text. The MLA system 102 corpus-based architecture of information stands in sharp contrast to the status quo approach of creating a modified static version of a work which lacks the capacity to be adaptively configured and further personalized in real-time to meet the needs of users. It should also be appreciated that ‘spontaneous’ adaptation of the information presented to individual users is distinct from making pre-scripted or user-requested alterations, or moving between pre-determined pathways within a work.

In some implementations, the NLP system 801 may employ multiple different AI models in NLP processing 804, each focused on generating a unique version of the original source material 802, such as a version at or below a specific comprehension level. Additional instances of an adaptive model or artificial intelligence model may then evaluate and refine the output of NLP processing 804 as part of the MLA system 102 and additional NLP processing 808. The MLA system 102 and NLP processing 808 may include checking the various outputs of NLP processing 804 and any editor contributions 806 against one another for coherence, consistency, and any form of quality. The resulting electronic content may then be merged together 202 into an MLA work that can be presented adaptively to users on their hardware devices 204.

Returning to the environment 600 of FIG. 6, the MLA application 612 may also include a user profile manager 616 component configured to store, modify, and access user profile information and data. For example, the user profile manager 616 may maintain a database, perhaps in the data source 626, of user identifiers, passwords, biographic information, and other information utilized by a consumer to access or otherwise register with the MLA system 102. User profiles 616 may also include data regarding user's skill level, demographics, medical diagnosis or conditions, records or summaries of previous information consumption, career or learning objectives, past traumatic experiences, subject matter specific content guidelines, personal calendar or work load calculations, and other types of information that may help establish the consumption preferences which are associated with registered users of the MLA system 102. The consumption preferences or skill level may be utilized by the MLA system 102 to determine an alteration to the source electronic content to present to the computing device 628 for display. For example, the user profile 616 for a user may indicate that the user reads at a third-grade level. Such user information may be determined by the MLA system 102 over time as the user interacts with the system, or may be provided directly to the user profile manager 616 via the computing device 628, or collected via another input mechanism such as an administrative dashboard. The MLA system 102 may then utilize the determined consumption preferences and reading level of the user and adapt instantiations of the electronic content accordingly. As explained in more detail below, the MLA system 102 may select portions of the corpus of the electronic content to provide to the computing device 628 for display based on the determined consumption preferences, such as the user's attention and interest in the subject matter of the electronic content, and skill level of the user. Further, the MLA system 102 may update a user's skill level during the consumption of electronic content by the user. For example, the user may become more skilled at reading during the use of the MLA system 102 over time such that the user's reading level increases. This increase may be detected by the MLA system 102 and the user's profile may be updated with the new skill level, or any other consumption preferences, such as the user's attention and interest in the subject matter of the electronic content, by the user profile manager 616. The user profile manager 616 may store the most recent determined skill level alongside personal information or consumption preferences of the user such that, when the user logs into the MLA system 102 to consume electronic content, the user's profile can be used by the MLA system to generate personalized instantiations of electronic content. For instance, a parent may contribute an input to the user profile manager 616 that sets an upper limit for the age appropriateness of electronic content for a child. This consumption preference may help protect a child from inappropriate content, and also ensure that a child does not become overwhelmed attempting to read works above their skill level. In response, the MLA system 102 may evaluate works for age appropriateness for the user and alter or adapt the content that would otherwise be presented accordingly.

The MLA application 612 may also include an interactions manager 618 configured to receive interactions with the computing device 628, and/or user interface 640 by the user during consumption of the electronic content. For example, the interactions manager 618 may monitor for and receive inputs provided to the computing device 628 during a timeframe in which a user is consuming the adaptive electronic content. Such inputs may be categorized and stored by the interactions manager 618 for determining a level of adaptive content to provide to the user. Inputs to the computing device 628 may include, but are not limited to, a selection to turn a virtual page within the electronic content, interactions with an image of the content, highlighting of text or images of the content, selection to receive additional information or a meaning about text, such as a word or phrase, and the like. In some instances, the inputs may be interpreted by the interactions manager 618 to aid in determining a user's engagement with the electronic content. For example, the interactions manager 618 may determine a speed at which the user is consuming the content and assign a reading level to the user's reading speed within the context of the work. Such determination may include dividing the number of words on a virtual page of the electronic content by the time between when the page is displayed and the user provides an input to turn to the next virtual page. The user's reading speed may be averaged over a session or stored for each page of the electronic content. In a similar manner, each interaction of the user with the computing device 628 while consuming the electronic content may be received, stored, and/or processed by the interactions manager 618. In other instances, the interpretation and processing of the user's interactions may be executed by the adaptation model 622, described in more detail below, and relevant information may also be stored in the user profile manager 616. For instance, in the context of a school a user may be expected to reach a certain point in a work by the start of a class period. The MLA system 102 may detect that the user is running behind the required schedule and adaptively reduce the simplicity of a personalized instantiation of the work to enable the user to stay on pace with their class. The resulting outcome may be stored in the user profile manager 616, and may result in the student receiving a lower grade.

A displayed content manager 620 component of the MLA application 612 may obtain at least a portion of the corpus from the corpus manager 614 and provide the portion to the computing device 628 for display on the device, such as through the user interface 640. In some instances, the displayed content manager 620 may receive an output from the adaptation model 622 indicating a skill level or consumption preferences, such as the user's attention and interest in the subject matter of the electronic content, of the user of the consumer device 628. The displayed content manager 620 may obtain a portion or portions of the corpus associated with the original work based on the output from the adaptation model 622, and transmit the obtained portion to the computing device 628. The portions of the corpus may be associated with various skill levels or consumption preferences such that the displayed content manager 620 may search the corpus for the content associated with the unique capacities, needs, interests, and goals of the user and output said adaptive electronic content. In this manner, the displayed content manager 620 may be configured to identify the aspects of the corpus corresponding to the user's level and consumption preferences, such as the user's attention and interest in the subject matter of the electronic content, and compile the optimal corpus aspects into the electronic content presentation. For instance, an embodiment of the invention might reduce the use of, or include additional explanation for, similes and metaphors within a work for a user who struggles with abstract language

In some instances, data managed by the user profile manager 616 and/or the interactions manager 618 may be provided to an adaptation model 622 component of the MLA application 612. The adaptation model 622 may determine which portion of the corpus for an electronic work to provide for display on the computing device 628 based on the information received from the user profile manager 616 and/or the interactions manager 618. For example, based on a provided reading level and consumption preferences, such as the user's attention and interest in the subject matter of the electronic content, for a user, the adaptation model 622 may provide a first adaptation of the original work from the corpus of the electronic content. As the user consumes the first adaptation from the corpus, the interactions manager 618 may determine an engagement level and changes in preferences of the user based on the user's interactions with the computing device 628. In response to a detected change, the adaptation model 622, either working in tandem or independently from the displayed content manager 620, may obtain different electronic content from the corpus and adapt the displayed content according to the user's interactions. In this manner, the adaptation model 622 may adapt the electronic content in real-time to the user's ability. For example, when a user returns to a work after a longer absence an embodiment of the invention might present the user with a simpler instantiation of the work at first to help the reader rebuild their momentum with the text. If a user then sustains their reading session an embodiment of the invention may adaptively increase the complexity of the instantiation of the work in real-time; possibly returning to presenting the source material itself as the user becomes re-acquainted with the writing style and re-invested in the material

In addition, the adaptation model 622 may be a machine-learning process that is updated by the model updater 624 based on feedback data and information received at the MLA application 612, or any other component of the MLA system 102. For example, a user of the computing device 628 may provide feedback on the adapted electronic content via the user interface 640 indicating if the content is provided in an effective manner. Such feedback may be provided to the model updater 624 which may update the adaptation model 622 based on the feedback. In particular, the model updater 624 may adjust one or more parameters of the adaptation model 622 that may improve the model's determination of the user's skill level or preferences both before and during consumption of the electronic content. In another example, the model updater 624 may receive interactions with the content from the interactions manager 618. The model updater 624 may, in turn, determine if the interactions suggest that the provided electronic content is appropriate for the user's skill level and consumption preferences, such as the user's attention and interest in the subject matter of the electronic content, and adjust the parameters, aspects, methods, etc. of the adaptation model 622 to improve the accuracy of the output of the model based on the interactions. All such data and information described above may also be stored or otherwise integrated in the user profile manager 616. In general, the model updater 624 may receive any information and/or data corresponding to the accuracy of the adaptation model 622, and adjust any aspect of the model or the user profile manager 616 based on the received information and/or data. The operations of the adaptation model 622, and the model updater 624, are both described in more detail below.

For instance, a user might indicate via inputs collected by the interactions manager 618 that they have a preference for additional concrete examples of theoretical concepts presented in a work, leading an embodiment of the invention to spontaneously adapt the electronic content and update the adaptation model 622 and user profile manager 616 via the model updater 624. Some implementations may then display additional examples through the user interface 640 on the computing device 628 and increase the frequency of examples included in the user's personalized instantiation of the work moving forward, whether drawn from the original source material, or generated by the MLA system 102, or otherwise included as part of the associated corpus for the work. This change or clarity in a user's consumption preferences may then inform the electronic content presented to the user in other works also consumed through the MLA system 102.

It should be appreciated that the components described herein are provided only as examples, and that the MLA application 612 may have different components, additional components, or fewer components than those described herein. For example, one or more components as described in FIG. 6 may be combined into a single component. As another example, certain components described herein may be encoded on, and executed on other computing systems. Further, more or fewer of the components discussed above with relation to the MLA platform 606 may be included with the platform, including additional components or modules included to perform the operations discussed herein.

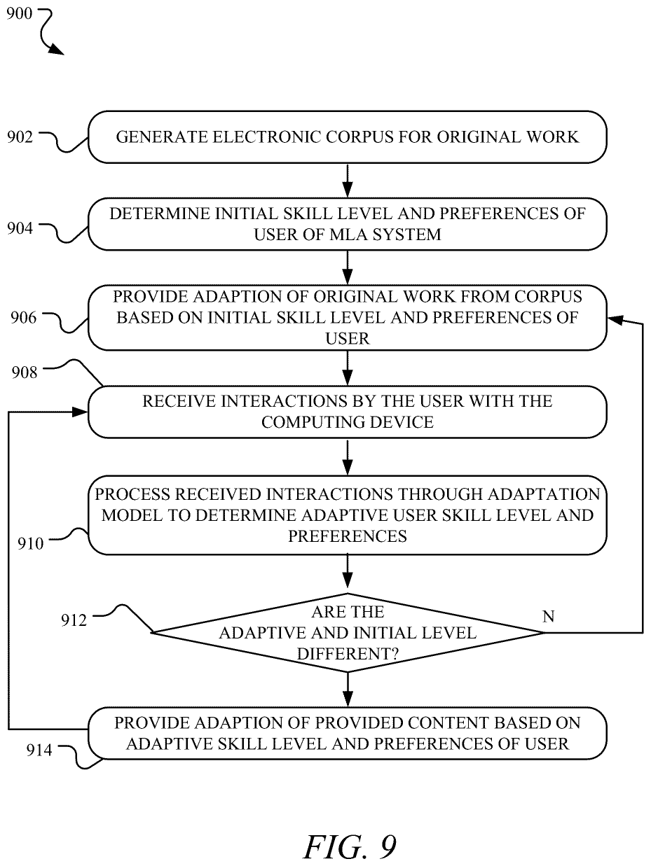

FIG. 9 is a flowchart of a method 900 for providing adapted electronic content from the MLA system 102 in accordance with one embodiment. The operations of the method 900 may be executed by one or more of the components of the MLA system 102 described above, through either the execution of software programs or hardware components of the system. Further, more or fewer operations may be performed as part of the method 900, and the discussed operations are just examples of possible operations executed by the MLA system 102 to provide adapted electronic content to a computing device for display and interactions.

Beginning in operation 902, the MLA system 102 may generate an electronic corpus of an original work, such as a textbook, novel, or any other type of piece. The corpus for the original work may include an electronic copy of the text and images of the original work, any number of adaptations or alterations to the original work, and attached or additional information. For example, the corpus may include alternate text and images that have similar meanings or intents to passages from the original work, alternate images to images included in the original work, additional text or images to aid in understanding the original work, contextual information for the meaning and history of the original work, and the like. In general, any number and types of alternate content may be included in the corpus of the electronic work. As explained above, the alternate content may be generated by an editor and provided to the MLA system 102 for association with the original content. In other implementations, the alternate content may be generated by a computing device, system, machine-learning program, or other application configured to generate alternate content for the corpus of the electronic work. Regardless of how the corpus is generated, the MLA system 102 associates the corpus to the original work for use in presenting an adaptive electronic content to a user of a computing device. For example, a work of Shakespeare such as Macbeth might be formed by an embodiment of the invention into a corpus that includes additional historical context, modern language, and various versions or interpretations of the play.

At operation 904, the MLA system 102 may determine an initial skill level and consumption preferences, such as the user's attention and interest in the subject matter of the electronic content, of a user of the computing device. In one example, the user of the computing device may be associated with a profile of the MLA system 102. The profile may include information or other indicators of a skill level and consumption preferences of the user. The initial skill level and consumption preferences may be provided by the user, an administrator, or another user of the MLA system, or may be generated by the MLA system 102 based on previous interactions with the user. In one example, a user may be prompted to answer a questionnaire and the initial skill level and consumption preferences, such as the user's attention and interest in the subject matter of the electronic content, of the user may be determined by the MLA system 102 from the answers. The MLA system 102 may also include a default initial skill level and other settings for every user until the system can determine the skill level and consumption preferences of the user through interactions with the computing device. When the user logs into the MLA system 102 to consume electronic content, the MLA system 102 may therefore determine the user's most recently stored skill level and consumption preferences, such as the user's attention and interest in the subject matter of the electronic content, for use in providing electronic content as requested by the user.

At operation 906, the MLA system 102 may provide an adaptation of the original work from the corpus associated with the work and based on the initial skill level and consumption preferences, such as the user's attention and interest in the subject matter of the electronic content, of the user. In particular, the MLA system 102 may determine what portions of the corpus associated with the original work are to be presented to a user based on the user's skill level and consumption preferences and generate a program for transmission to the computing device with the determined portions. The computing device may execute a software program to display the determined portion, or portions, on a display device. In some instances, the MLA system 102 may initially provide the original work without adaptation and provide adaptations of the original work as the user interacts with the computing device on an ongoing basis. In other instances, the MLA system 102 may provide an adaptation of the original work based on a determined user skill level and consumption preferences, such as the user's attention and interest in the subject matter of the electronic content. The provided adaptation may include portions of the original work, portions of the additions to the original work, all of the original work, or all adaptations to the original work. In general, any portion of the corpus may be provided to the computing device based on the determined initial skill level of the user.

It should be appreciated that providing the adaptation of the original work may include providing less than the whole of the original work or the adaptations. For example, the MLA system 102 may provide one “paragraph” of text to the computing device at a time, and until a request for the next “paragraph” is requested from the device. In other examples, the MLA system 102 may provide several electronic pages worth of text and/or images to the computing device. By transmitting less than the whole of the adapted work, the MLA system 102 may adapt the electronic content provided to the computing device in real-time, or near real-time, as each new batch of the electronic content is requested by the computing device. The amount of the adapted or non-adapted content transmitted to the computing device may depend on several factors, including the size of the display of the computing device, the size of the electronic content, the type and configuration of the original work, and the like.

The MLA system 102 may receive one or more interactions of the user with the computing device while viewing or otherwise consuming the provided electronic content in operation 908. Such interactions may include active interactions with the computing device 204 by the user (e.g., touches on the screen, highlighting of text, signals received from an input device to interact with the text directly) and passive interactions (e.g., average viewing velocity, intervals between sessions, backwards movement in a work, etc.). In general, any interaction received at the computing device while the electronic content is displayed may be obtained and/or sent to the MLA system 102.

Further, at operation 910, the MLA system 102 may process the received interactions through an adaptation model to determine an adapted user skill level and/or determine alternate content to present from the corpus for the original work based on the adapted user skill level and consumption preferences. In general, a learning platform comprising an adaptation model may be included with the MLA system 102 to receive inputs, such as user interactions with the computing device, and output a determined skill level for the user based on the interactions. Other inputs may also be provided to the model, including biographic data of the user, the initial skill level associated with the user, historic data associated with the user, historic data associated with other users of the MLA system 102, threshold values corresponding to various consumption skill levels, and the like. The model may process the various inputs and determine a skill level and consumption preferences, such as the user's attention and interest in the subject matter of the electronic content of the user, based on the inputs. In other implementations, the model may process the various inputs and determine which particular portions of the corpus associated with the original work to provide to the computing device. Further, as explained in more detail below, the adaptation model may include one or more machine-learning or artificial intelligence algorithms to improve the accuracy of the model. For example, feedback or data of the accuracy of the output of the model may be received and used to adjust parameters, settings, threshold values, etc. of the model, to improve the determination of the user's skill level and consumption preferences, and/or identify altered content to provide to the user based on a user's determined capacities, needs, interests, and goals. For example, a user with a large work load and busy schedule may choose to receive a simpler instantiation of a book from an embodiment of the invention due to their other time commitments. Depending on the user's interest in the electronic content, and how their calendar evolves, an embodiment of the invention may then further simplify or increase the complexity of the personalized configuration of the work in real-time.

At operation 912, the MLA system 102 may determine if the user's skill level, interest, or engagement with the work merits the presentation of a revised instantiation or adaptation. For instance, the MLA system 102 may consider if the user's skill level or consumption preferences, such as the user's attention and interest in the subject matter of the electronic content, are different than the user's initial skill level or consumption preferences 904. For example, the MLA system 102 may determine that the user reads at a sixth-grade level when initially accessing the electronic content 904 and provides a requested electronic content according to the sixth-grade reading level 906. However, during consumption of the sixth-grade level content, the MLA system 102 may determine that the user is, at least temporarily, capable of reading at a seventh-grade level. Such a determination may be based on the user's interactions with the computing device, such as the speed at which the user is consuming the content, whether the user is requesting more or fewer images, requests to define particular words in the text, and the like. In general, the adapted user skill level and consumption preferences, such as the user's attention and interest in the subject matter of the electronic content, may be based on any information or data obtained or transmitted to the MLA system 102, including interactions, user profile data, and historical data associated with the original work. For instance, a user may typically be a strong reader but suddenly suffers a trauma, whether a medical diagnosis, loss of loved one, or some other change in circumstance. The user's reading capability may be temporarily or permanently diminished, and an embodiment of the invention may adapt the electronic content presented to the user accordingly. In contrast, a user may receive the right prescription on their eye-glasses and finds their capacity for reading immediately improves, leading the MLA system 102 to adapt the electronic content presented to the user accordingly.

If the MLA system 102 determines that the user's skill level and consumption preferences, such as the user's attention and interest in the subject matter of the electronic content, has not changed, the system may continue to provide the electronic content associated with the user's initial skill level at operation 906. In other words, the MLA system 102 may continue to obtain the portions of the corpus for the original work associated with the user's initial skill level and consumption preferences and transmit those portions to the computing device for display. Alternatively, the MLA system 102 may determine that the user's skill level and consumption preferences has changed. The user's skill level and consumption preferences, such as the user's attention and interest in the subject matter of the electronic content, may increase or decrease based on the user's interactions with the provided electronic content. In such cases, the MLA system 102 may identify portions of the corpus associated with the user's current skill level and consumption preferences and provide those portions to the computing device for consumption by the user at operation 914. By providing the portions of the corpus associated with the user's current skill level and consumption preferences, such as the user's attention and interest in the subject matter of the electronic content, the MLA system 102 may adapt the electronic content in real-time based on the user's interactions with the computing device. After providing the adapted electronic content from the corpus to the computing device, the MLA system 102 may return to operation 908 to receive the interactions of the user with the computing device. Through the method 900, the MLA system 102 may iteratively monitor and process a skill level and consumption preferences, such as the user's attention and interest in the subject matter of the electronic content, of a consumer of electronic content on an ongoing basis, and provide adapted versions of an original work tailored to the user's unique capacities, needs, interests, and goals in response. The system may aid a user in accessing and engaging with an original work by presenting the work at a preferred level for the user. This may encourage learning and growth by the user, and avoid frustration that may come from consuming content above a user's ability or outside of a user's interest. It should be appreciated once again that through the method 900 the user physically interacts with, and contributes inputs to, their dedicated instantiation of the electronic content which may optimize, in real time, to present information in a way that is tailored to the end-user's specific needs and capacities. In other words, through the systems and methods described herein, a user meaningfully creates their own creative work.

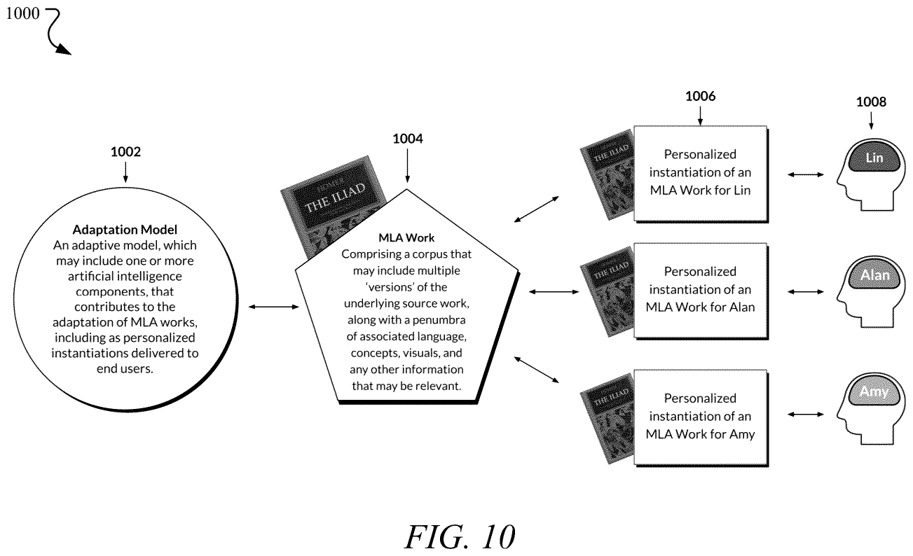

FIG. 10 is a schematic diagram illustrating the generation of multiple instantiations of an MLA work 1006 as personalized electronic content for different users 1008 through the functioning of an adaptation model 1002 modifying and configuring a work specific corpus 1004, as discussed above with reference to the method 900 of FIG. 9. Through the method 900, a corpus 1004 comprising informational material or content (particularly text and images) may be generated by the MLA system 102. As described above, the MLA system 102 may generate portions or all of the corpus associated with the work. Further, the adaptive model may contribute to the corpus of the work. In particular, based on feedback received from one or more users of the MLA system 102, the model may identify portions of the corpus that best fit the various skill levels of the users 1008. For example, a portion or instantiation 1006 of the corpus 1004 may be provided for a particular skill level and consumption preferences, such as the user's attention and interest in the subject matter of the electronic content. However, through interactions received by the MLA system 102 over time, the model may determine that a portion of the corpus is better understood by users 1008 with a higher skill level or a different consumption preferences. In this circumstance, the MLA system 102 may update the skill level or consumption preferences that are associated with the portion of the corpus 1004 accordingly. In this manner, feedback of interactions by users 1008 with the portions of any of the instantiations 1006 of the corpus 1004 managed by the MLA system 102 may be processed through the model 1002 to determine the best fit skill level and consumption preferences for the portions of the MLA work. Even further, the adaptation model 1002 may manage a vast diversity and range of corpora for different MLA works 1004, and integrate the inputs of countless users 1008 provided to their personal instantiations 1006 to improve the broader functioning of the MLA system 102.

In other words, each user 1008 physically interacts with, and contributes inputs to, their dedicated instantiation 1006 of the MLA Work 1004. The MLA system 102 may then adaptively optimize, in real time, the information presented through an instantiation 1006 in a way that is tailored to the users' 1008 specific needs and capacities. This leads to both further refinements and configurations of the text and visuals being presented within an instantiation 1006, and also provides the overarching adaptation model 1002 that helps generate and govern each corpus 1004 and instantiation of an MLA Work 1006 with additional data on the ways that users respond to the content presented to them. This process leads the MLA system 102 to develop an even more robust understanding and compilation of visuals, text, and structures that it can present moving forward in future instantiations 1006 of MLA works 1004.

The MLA system 102 may generate multiple adaptations or instantiations 1006 of the corpus for a particular original work 1004 corresponding to multiple skill levels and consumption preferences of users 1008 of the MLA system. The MLA system 102 may also determine a current skill level and consumption preferences for users 1008 of the MLA system. Through the method 900 above, the MLA system 102 may provide an adaptation 1006 from the corpus of the work 1004 based on a determined skill level and consumption preferences corresponding to the individual users 1008 of the MLA system. Thus, each user 1008 of the MLA system 102 receives a different instantiation 1006 of the original work 1004 that is based on the determination of the user's skill level and consumption preferences, such as the user's attention and interest in the subject matter of the electronic content. Further, the electronic content provided to the user (via the computing device) may be altered or otherwise adapted based on an iterative processing of the user's 1008 skill level and consumption preferences as the user consumes the provided electronic content. For example, users of a biology textbook may have different learning goals that an embodiment of the invention may respond to by adaptively personalizing and presenting the original material. One user may be interested in memorable, high level summaries of key concepts because they do not intend to pursue further study in the field, but still want to understand its core tenets. A second user may be planning to pursue a career related to biology and desire comprehensive details that may even expand beyond the content included in the original work. The MLA system 102 may deliver custom configurations, or instantiations 1006 of the electronic content to each of these users in line with their individual preferences. Ultimately, the MLA system 102 may present millions of different variations, adaptations, instantiations, or what can even be called ‘flavors’ of the original source to millions of different users.

As mentioned above, the adaptation model 1002 of the MLA system 102 may perform several functions. For example, the model 1002 may be configured to determine which portions of the corpus to provide to a user based on their skill level and consumption preferences, such as the user's attention and interest in the subject matter of the electronic content. As described above, the corpus for a work 1004 may include the original work and adaptations of the work associated with various skill levels. The model 1002 may therefore be configured to associate the specific portions of the corpus 1004 with a particular user. For example, a first portion of the corpus 1004 may be associated with a first-grade reading user and a second portion may be associated with a third-grade reading user as determined by the model. In one implementation, the model may utilize feedback from interactions of users 1008 with the MLA system 102 to determine which portions are to be associated with which skill level. For example, the model 1002 may receive interactions with a particular portion of the corpus 1004 from a first user or set of users 1008 associated with a first skill level. Based on those interactions, the model 1002 may determine that the portions are more relevant to a skill level different than the first skill level and associate those portions of the corpus 1004 with the different skill level. Some or all of a corpus 1004 may be similarly categorized to be associated with one or more skill levels. Adaptations of the electronic work 1006 may thereby be generated by obtaining the portions of the corpus 1004 that are associated with a user's determined skill level. For instance, a corpus 1004 might be structured through association with grade levels, comprehension levels, or any other categorization system such as beginner, intermediate, and advanced

In addition, a model 1002 may be configured to determine the skill level and consumption preferences, such as the user's attention and interest in the subject matter of the electronic content, of a user 1008 of the MLA system 102 through interactions with the computing device and/or information included in a user profile. In some instances, the model 1002 may determine the skill level and consumption preferences of the user 1008 as the user is interacting with provided electronic content 1006 from the corpus 1004 to provide adaptations of the presented work in real-time. In other instances, the model 1002 may determine the skill level of the user from biographic or other information from a user profile. Thus, the machine-learning model 1002 of the MLA system 102 may determine a skill level and consumption preferences, such as the user's attention and interest in the subject matter of the electronic content, of the user 1008 and/or determine which portions of a corpus 1004 to provide to the user based on the historical and real-time information. For example, a user's profile might include information regarding prior history of abuse, or other types of potential content triggers. The MLA system 102 may incorporate such data when determining which electronic content to provide from the corpus 1004, including executing techniques such as summarizing relevant content or reducing graphical details in instantiations 1006 to protect and preserve the user's reading experience.

In general, every instantiation 1006 of a corpus 1004 presented as adaptive electronic content may produce one or more interactions with one or more end-users 1008 that may be provided back to the MLA system 102 for future operations of the model of the MLA system. In this manner, the machine-learning adaptive model 1002 may utilize feedback data from a portion or all of the users 1008 of the MLA system 102 to refine the model processes. Thus, the adaptive model 1002 may train on, and evolve through, repeated interactions with source texts, editors/collaborators, and the execution of the MLA method 900 described herein. The model 1002 may then leverage its training and generate corpora to adaptively display to individual end-users through custom instantiations of an original work on a personalized basis. Each user 1008 may interact with, and contribute inputs to, a dedicated instantiation 1006 of the electronic content which may then optimize or adapt itself, in real time, to present information in a way that is tailored to the end-user's specific needs and capacities. This leads to both further refinements and configurations of the text and visuals being presented within an instantiation 1006 and provides the overarching machine learning model 1002 that generates and governs each instantiation of MLA works 1004 and electronic content with additional data on the ways that human end-users 1008 respond to the content presented to them. This process leads the adaption model 1002 of the MLA system 102 to develop an even more robust understanding and compilation of visuals, text, and structures that it can present to users 1008 moving forward in future instantiations 1006 of corpuses 1004 presented as electronic content.

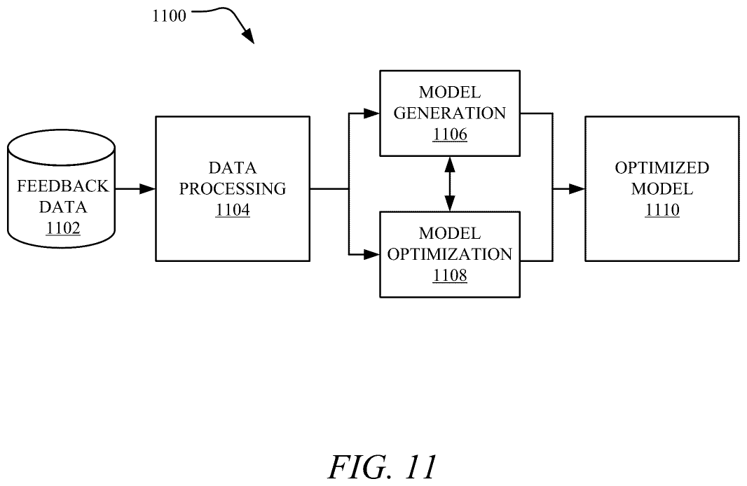

FIG. 11 is a block diagram illustrating an example data flow 1100 for generating and optimizing the adaptation model for the MLA system 102 discussed above. Through the data flow 1100, an adaptive model may be generated and updated by incorporating data from multiple interactions from multiple users resulting in a more accurate model for analyzing user inputs and/or selecting portions of a corpus to provide to a user as a personalized instantiation 1006 based on the user's skill level and consumption preferences, such as the user's attention and interest in the subject matter of the electronic content. Initially, the data flow 1100 may include a database 1102 of feedback data as an input to a machine learning system. The feedback data 1102 may include, among other types of data, interactions with a computing device while a user consumes the electronic content, answers provided to the MLA system 102 in response to a prompt about the user's experience, passive interactions with the computing device (such as an amount of time a user views a particular page of the content), information associated with a particular user, information provided to the MLA system by an administrative dashboard, and the like. In general, any data or information that may provide an indication of a user's experience while consuming provided content may be included in the feedback data 1102.

The feedback data 1102 may be processed through a data processing technique 1104 to determine a generalized success of an output of the adaptation model based on the feedback data 1102. For example, the data may be processed 1104 to determine how long a user takes to consume provided electronic content, how often the user requests a meaning of a particular word, a user's response to a survey about the user's experience, and any other input obtained by the MLA system 102. In general, any information that may indicate an accuracy or effectiveness of the adaptive model providing appropriate portions of the corpus to a user may be determined at the data processing step 1104 of the data flow 1100.

Portions of the data flow 1100 of FIG. 11 may utilize the processed dataset 1104 to execute one or more of the operations to generate and/or optimize an adaptation model for the MLA system 102. The operations may be performed by a computing device configured to execute any machine learning or artificial intelligent algorithm, including deep learning techniques. Such operations may be executed through control of one or more hardware components, one or more software programs, or a combination of both hardware and software components of the computing device. In one implementation, a computing device of the MLA system 102 may iteratively train multiple models, based on the processed feedback data 1104, to generate an adaptive model. In particular, and using the data flow 1100 as an example, the processed feedback data 1104 may be provided to a model generation 1106 and/or model optimization 1108 system. The model generation system 1106 may use artificial intelligence technology to generate one or more models using the processed feedback data 1104. In addition, the MLA system 102 may use the model optimization system 1108 to train the one or more generated models to provide more accurate results. The model optimization 1108 may also use the processed data 1104 to refine and improve the generated models. This iterative process of model generation and/or optimization may be repeated thousands of times to enable models with different parameters (aspects unique to the architecture of the model) to be trained and tested. The resulting best model according to standard regression metrics may then be chosen and output as an optimized forecast model 1110.

As mentioned above, the feedback data 1102 may provide an indication of the accuracy of the adaptive model to determine portions of a corpus to provide to a user based on the user's skill level. Such feedback data 1102 may be used for training the adaptive model of the MLA system 102. For example, the adaptive model may determine a user's skill level and consumption preferences, such as the user's attention and interest in the subject matter of the electronic content, and provide a portion of the corpus to the user based on that information. However, the feedback data 1102, once processed by the MLA system 102, may indicate that the selected portions of the corpus was difficult for the user to understand, too simple for the user, or any other type of user preference or experience. In response, the MLA system 102 may revise aspects of the machine-learning adaptive model to provide a more accurate portion of the corpus to the user. The revision to the adaptive model may include adjusting a parameter, a ruleset, a threshold level or value, definitions of possible user skill levels, a weighted value, generating a personalized consumption level, associating a portion of the corpus to a newly generated consumption level, associating a portion of the corpus to a different consumption level, or any other aspect of the adaptive model to improve the accuracy of the output of the model. Further, revision to the adaptive model may be made to improve the determination of the user's skill level and consumption preferences, and/or the identification of the portions of the corpus best suited for the user's capacities, needs, interests, and goals.

In this manner, the MLA system 102 may utilize real-world outcome indicators to train and improve the adaptive model of the MLA system 102 through one or more machine-learning techniques. In particular, one or more of the parameters and/or rulesets of the adaptive model may be iteratively updated based on the feedback data 1102 processed by the MLA system. Through this iterative learning process, the parameters, rulesets, threshold values, and the like of the adaptive model may be refined to be more accurate as more and more feedback data from the multiple users of the MLA system is received and used for training. The skill level determination and/or corpus portion selection generated by the adaptive model may therefore become more accurate through training using the training feedback data 1102.

The ultimate promise of the MLA system's 102 capacity to adaptively generate and configure personalized text and visuals as electronic content for end users when operating as part of the larger technology system described in this document is to:
1) Keep every viewer in their zone of proximal development when consuming information; and
2) Continuously find opportunities to help support the growth of end users' knowledge, and information comprehension skills, by introducing an appropriate level of complexity and context for the material presented.

For instance, within the context of a longer work like a book, a user might start with 7th grade material but finish the book at an 8th grade level because the MLA system's 102 careful monitoring or their engagement allows an implementation of the MLA system 102 to adaptively configure the text and visuals to increase the work's complexity over time. In other words, by working from an underlying corpus of material developed by the MLA system 102, the platform can algorithmically ‘rate-up’, or ‘rate-down’, the ‘level’ of each individual instantiation of a work for an individual user. This unique configuration of personalized text and visuals is then presented to an end-user through a software display program.

In particular, this software display program has the capability, in combination with a generative artificial intelligence platform, to automatically display custom text, images, and other sorts of visuals. For example, a user might enable a setting to always see images accompanying stories, instructing the artificial intelligence platform and software display program to work in tandem to constantly generate custom visual scenes based on the language being presented to the user. Other visuals that the software display program can present include videos, dynamic text formatting, highlighting, annotations, and more. For example, a user consuming an abridged instantiation of an electronic work might click to see a visual presentation of the original material developed by the author. For end-users who are consuming works, the software display program and the computing device it is hosted on provide an interface to interact with and benefit from content. In addition, and separate from the adaptive display of text and visuals in electronic content, additional capabilities like settings, preferences, account details, and other standard elements of modern software platforms may be included with one embodiment of this component of the technology disclosed.

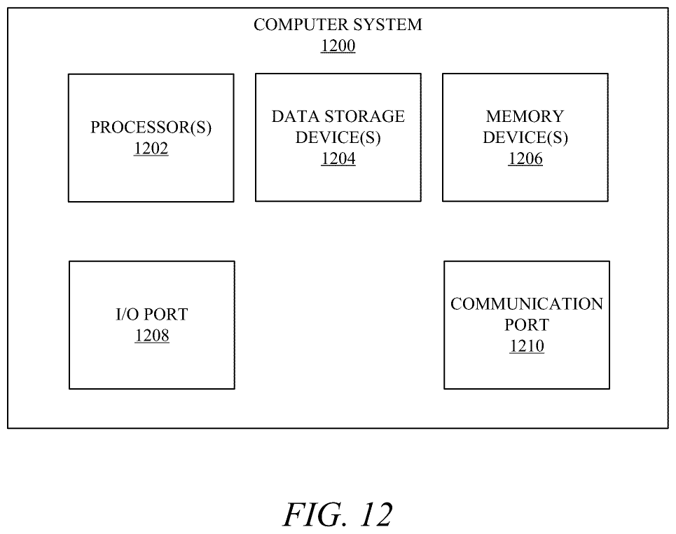

Referring to FIG. 12, a detailed description of an example computing system 1200 having one or more computing units that may implement various systems and methods discussed herein is provided. The computing system 1200 may be applicable to the multiple-level adaptation system 102 of FIG. 1, and other computing or network devices. It will be appreciated that specific implementations of these devices may be of differing possible specific computing architectures not all of which are specifically discussed herein but will be understood by those of ordinary skill in the art.

The computer system 1200 may be a computing system capable of executing a computer program product to execute a computer process. Data and program files may be input to the computer system 1200, which reads the files and executes the programs therein. Some of the elements of the computer system 1200 are shown in FIG. 12, including one or more hardware processors 1202, one or more data storage devices 1204, one or more memory devices 1208, and/or one or more ports 1208-1210. Additionally, other elements that will be recognized by those skilled in the art may be included in the computing system 1200 but are not explicitly depicted in FIG. 12 or discussed further herein. Various elements of the computer system 1200 may communicate with one another by way of one or more communication buses, point-to-point communication paths, or other communication means not explicitly depicted in FIG. 12.

The processor 1202 may include, for example, a central processing unit (CPU), a microprocessor, a microcontroller, a digital signal processor (DSP), and/or one or more internal levels of cache. There may be one or more processors 1202, such that the processor 1202 comprises a single central-processing unit, or a plurality of processing units capable of executing instructions and performing operations in parallel with each other, commonly referred to as a parallel processing environment.

The computer system 1200 may be a conventional computer, a distributed computer, or any other type of computer, such as one or more external computers made available via a cloud computing architecture. The presently described technology is optionally implemented in software stored on the data stored device(s) 1204, stored on the memory device(s) 1206, and/or communicated via one or more of the ports 1208-1210, thereby transforming the computer system 1200 in FIG. 12 to a special purpose machine for implementing the operations described herein. Examples of the computer system 1200 include personal computers, terminals, workstations, mobile phones, tablets, laptops, personal computers, multimedia consoles, gaming consoles, set top boxes, and the like.

The one or more data storage devices 1204 may include any non-volatile data storage device capable of storing data generated or employed within the computing system 1200, such as computer executable instructions for performing a computer process, which may include instructions of both application programs and an operating system (OS) that manages the various components of the computing system 1200. The data storage devices 1204 may include, without limitation, magnetic disk drives, optical disk drives, solid state drives (SSDs), flash drives, and the like. The data storage devices 1204 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 1206 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 1204 and/or the memory devices 1206, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computer system 1200 includes one or more ports, such as an input/output (I/O) port 1208 and a communication port 1210, for communicating with other computing, network, or reservoir development devices. It will be appreciated that the ports 1208-1210 may be combined or separate and that more or fewer ports may be included in the computer system 1200.

The I/O port 1208 may be connected to an I/O device, or other device, by which information is input to or output from the computing system 1200. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 1200 via the I/O port 1208. Similarly, the output devices may convert electrical signals received from computing system 1200 via the I/O port 1208 into signals that may be sensed as output by a human, such as sound, light, and/or touch. The input device may be an alphanumeric input device, including alphanumeric and other keys for communicating information and/or command selections to the processor 1202 via the I/O port 1208. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing system 1200 via the I/O port 1208. For example, an electrical signal generated within the computing system 1200 may be converted to another type of signal, and/or vice-versa. In one implementation, the environment transducer devices sense characteristics or aspects of an environment local to or remote from the computing device 1200, such as, light, sound, temperature, pressure, magnetic field, electric field, chemical properties, physical movement, orientation, acceleration, gravity, and/or the like. Further, the environment transducer devices may generate signals to impose some effect on the environment either local to or remote from the example computing device 1200, such as, physical movement of some object (e.g., a mechanical actuator), heating or cooling of a substance, adding a chemical substance, and/or the like.

In one implementation, a communication port 1210 is connected to a network by way of which the computer system 1200 may receive network data useful in executing the methods and systems set out herein as well as transmitting information and network configuration changes determined thereby. Stated differently, the communication port 1210 connects the computer system 1200 to one or more communication interface devices configured to transmit and/or receive information between the computing system 1200 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 1210 to communicate one or more other machines, either directly over a point-to-point communication path, over a wide area network (WAN) (e.g., the Internet), over a local area network (LAN), over a cellular (e.g., third generation (3G) or fourth generation (4G) or fifth generation (5G) network), or over another communication means. Further, the communication port 1210 may communicate with an antenna or other link for electromagnetic signal transmission and/or reception.

In an example implementation, the MLA system 102, and software and other modules and services may be embodied by instructions stored on the data storage devices 1204 and/or the memory devices 1206 and executed by the processor 1202. The computer system 1200 may be integrated with or otherwise form part of the MLA system 102.

The system set forth in FIG. 12 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given herein. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

We claim:

1. A computer-implemented method for adaptive electronic content generation, the computer-implemented method comprising:
obtaining, at a processing device in communication with a tangible storage medium storing instructions that are executed by the processing device, a corpus of electronic documents associated with an instance of consumable electronic content;
executing, by the processing device, a machine-learning model to generate an initial variation of the electronic content based on an initial consumption level of a user, the initial consumption level of the user based on information obtained from a user profile associated with the user;
receiving one or more inputs comprising at least one physical input to a computing system displaying the initial variation of the electronic content;
generating, by the machine-learning model, and based on the received one or more inputs, an adapted variation of the electronic content customized to a determined second consumption level of the user;
receiving consumption data indicating a user's interactions with the computing system during a consumption of the adapted variation of the electronic content; and
altering, based on the received consumption data, at least one parameter of the machine-learning model, wherein the altered parameter causes the machine-learning model to generate an updated variation of the electronic content.

2. The computer-implemented method of claim 1, wherein altering the at least one parameter of the machine-learning model comprises at least one of increasing a weighted value, decreasing a weighted value, generating a personalized consumption level, associating a portion of the corpus to a newly generated consumption level, or associating a portion of the corpus to a different consumption level.

3. The computer-implemented method of claim 1, wherein generating the updated variation of the electronic content comprises associating a new portion of the corpus to the updated variation of the electronic content based on the second consumption level of the user.

4. The computer-implemented method of claim 3, wherein the new portion of the corpus comprises one of a passage of text from the corpus, an image or visual from the corpus, or a summary of a previous portion of the corpus.

5. The computer-implemented method of claim 1, wherein the consumption data comprises at least one of a response to a query displayed by the computing system, signals received via an input device to the computing system, a period of time between inputs, or a biometric of the user received from a sensor.

6. The computer-implemented method of claim 1 further comprising:
receiving consumption data indicating a second user's interactions during a consumption of a second adapted variation of the electronic content by the second user; and
altering, based on the received consumption data of the second user, the at least one parameter of the machine-learning model.

7. The computer-implemented method of claim 6 further comprising:
maintaining the machine-learning model at a central computing device, wherein the central computing device receives, via a network, the user's interactions from the computing system and the second user's interactions from a second computing system.

8. A system for adaptive display of electronic content, the system comprising:
a processor in communication with a tangible storage medium storing instructions that are executed by the processor to:
obtain a corpus of electronic documents associated with an instance of consumable electronic content;
display, on a display device of a computing device, an initial variation of the electronic content based on an initial consumption level associated with a user of the computing device;
receive, from the computing device, one or more inputs during an interaction with the initial variation of the electronic content;
generate, by an adaptive machine-learning model, and based on the received one or more inputs, an adapted variation of the electronic content, the adapted variation of the electronic content customized to a determined consumption level of a consumer of the initial variation of the electronic content; and
display, on the display device, the adapted variation of the electronic content customized to the consumption level of the consumer.

9. The system of claim 8 wherein the processor is further to:
receive a plurality of training adaptations of the electronic content; and
alter at least one parameter of the adaptive machine-learning model based on the plurality of training adaptations of the electronic content.

10. The system of claim 8, wherein the adapted variation of the electronic content comprises at least one text and at least one image corresponding to the electronic content.

11. The system of claim 8, wherein the adaptive machine-learning model is further to:
correlate the one or more inputs received from the computing device into the determined consumption level of the consumer of the initial variation of the electronic content.

12. The system of claim 11, wherein the determined consumption level of the consumer is based on at least one of a number of touches on the display device by the consumer, a determined average viewing velocity of the consumer, a time interval between activation of the computing device, an indication of backwards movement in the electronic content by the consumer, eye tracking of the user received from an optical sensor, or biometric signals of the user received from a sensor.

13. The system of claim 8, wherein the processor is further to:
store the adapted variation of the electronic content as associated with the consumer; and
associate the adapted variation of the electronic content with a user profile of the consumer, the user profile comprising an initial consumption level of the user and a current consumption level of the user.

14. The system of claim 8, wherein the processor is further to:
adapt the adapted variation of the electronic content based on additional inputs received at the adaptive machine-learning model from the computing device to a third variation of the electronic content, the third variation of the electronic content customized to a second determined consumption level of the consumer determined by the machine-learning model.

15. The system of claim 8, wherein the adapted variation of the electronic content comprises at least one of an alteration of vocabulary, syntax structure, or complexity of the source subject matter, a generated visual aid, an alteration to a visual aid, or accessibility of abstract concepts of the corpus of electronic documents.

16. The system of claim 8, wherein the is processor further to:
receive, via the computing device, feedback data associated with the displayed adapted variation of the electronic content; and
alter the adapted variation of the electronic content based on the indication of the feedback data.

17. The system of claim 16, wherein the feedback data comprises a response to a prompt provided to a consumer and based on a consumer's experience with adapted variation of the electronic content.

18. The system of claim 17, wherein the prompt is embedded within the displayed adapted variation of the electronic content.

19. The system of claim 13, wherein the processor is further to:
receive, via a web portal, one or more parameters of the user, wherein the adapted variation of the electronic content is based at least on the one or more parameters of the user; and
store the one or more parameters in the user profile.

20. The system of claim 8, wherein the processor and tangible storage medium are embodied in a central server.

21. The system of claim 20, wherein the central server receives one or more inputs from a second computing device, the adapted variation of the electronic content based at least one the one or more inputs from the second computing device.

22. A computer-implemented method comprising:
obtaining, at a processing device in communication with a tangible storage medium storing instructions that are executed by the processing device, a corpus of electronic documents associated with an instance of consumable electronic content;
displaying, on a display device associated with the processing device, an initial variation of the electronic content based on an initial consumption level associated with a user of the computing device;
generating, by an adaptive machine-learning model, and based on the received one or more inputs at the processing device, an adapted variation of the electronic content customized to a determined consumption level of a consumer of the initial variation of the electronic content; and
displaying, on the display device, the adapted variation of the electronic content customized to the consumption level of the consumer.

23. The method of claim 22 further comprising:
receiving a plurality of training adaptations of the electronic content; and
altering at least one parameter of the adaptive machine-learning model based on the plurality of training adaptations of the electronic content.

24. The method of claim 22, wherein the adapted variation of the electronic content comprises at least one text and at least one image corresponding to the electronic content.

25. The method of claim 22 further comprising: correlating the one or more inputs received from the computing device into the determined consumption level of the consumer of the initial variation of the electronic content.
